(19) United States
(12) Patent Application Publication
(10) Pub. No.: US 2005/0085148 A1
(43) Pub. Date: Apr. 21, 2005

(54) Felt for forming fiber cement articles with multiplex base fabric

(76) Inventors: Thomas Baumgartner, Warth (AT); Hippolit Gstrein, Gloggnitz (AT)

Correspondence Address: MYERS BIGEL SIBLEY & SAJOVEC, PO BOX 37428, RALEIGH, NC, 27627, US

(21) Appl. No.: 10/687,890

(22) Filed: Oct. 17, 2003

(51) Int. Cl. B32B 13/02; D03D 13/00; D03D 25/00; D03D 15/00; B32B 31/00; B31B 1/60; B65C 1/00; B65B 1/00; B32B 13/14

(52) U.S. Cl. 442/279; 442/42; 442/203; 442/208; 156/60

(57) ABSTRACT

A fiber cement felt includes a fabric and a batt layer. The fabric includes: a set of fine top machine direction yams; a set of coarse bottom machine direction yarns; and a set of fine cross machine direction yams interwoven with the top and bottom machine direction yams in a plurality of repeat units. The batt layer overlies and is attached to the set of top machine direction yams of the fabric. The fineness of the yams of the top machine direction yams and the cross machine direction yams can improve the surface achieved with other fiber cement felts

### FIELD OF THE INVENTION

The present invention relates generally to fabrics, and more particularly to fabrics employed to form articles of fiber cement.

### BACKGROUND OF THE INVENTION

Fiber cement is a well-known material employed in many building components, such as siding, roofing and interior structures, as well as pipes, particularly for waste water transport. Fiber cement typically comprises a mixture of cement (i.e., lime, silica and alumina), clay, a thickener, inorganic fillers such as calcium carbonate, and one or more fibrous materials. In the past, asbestos was commonly included as the fibrous material (see U.S. Pat. No. 4,216,043 to Gazzard et al.); because of the well-documented problems asbestos presents, now fiber cement typically includes a natural or synthetic fiber, such as acrylic, aramid, polyvinyl alcohol, polypropylene, cellulose or cotton. Fiber cement is popular for the aforementioned applications because of its combination of strength, rigidity, impact resistance, hydrolytic stability, and low thermal expansion/contraction coefficient.

To be used in siding or roofing components, fiber cement is often formed in sheets or tubes that can be used “as is” or later cut or otherwise fashioned into a desired shape. One technique of forming fiber cement articles (known as the Hatschek process) involves creating an aqueous fiber cement slurry of the components described above, depositing the slurry as a thin sheet or web on a porous fabric belt, and conveying the slurry over and through a series of rollers to flatten and shape the slurry. As the slurry is conveyed, moisture contained therein drains through openings in the fabric. Moisture removal is typically augmented by the application of vacuum to the slurry through the fabric (usually via a suction box located beneath the porous fabric). After passing through a set of press rolls, the fiber cement web can be dried and cut into individual sheets, collected on a collection cylinder for subsequent unrolling and cutting into individual sheets, or collected as a series of overlying layers on a collecting cylinder that ultimately forms a fiber cement tube.

The porous fabric used to support the slurry as moisture is removed is typically woven from very coarse (between about 2500 and 3000 dtex) polyamide yams. Most commonly, the yarns are woven in a “plain weave” pattern, although other patterns, such as twills and satins, have also been used. Once they are woven, the yams are covered on the “sheet side” of the fabric (i.e., the side of the fabric that contacts the fiber cement slurry) with a batt layer; on some occasions, the “machine side” of the fabric (i.e., the side of the fabric that does not contact the slurry directly) is also covered with a batt layer. The batt layer assists in the retrieval, or “pick-up,” of the slurry from a vat or other container for processing. Because of the presence of the batt layer(s), the fabric is typically referred to as a fiber cement “felt.”

Coarse yams have typically been employed in fiber cement felts because of the severe conditions the felt experiences during processing. For example, fiber cement felts are typically exposed to high load conditions by the forming machine. Also, there can be significant variations in tension over the felt length on the fiber cement machine, as tension may vary from as low as 2 kilopounds/cm after the forming roll to as high as 15 kilopounds/cm over suction boxes. As a result, coarse yarns having high “tenacity” and resilience have been employed. However, because the yarns are coarse, such felts have a tendency to mark the surface of the fiber cement product formed thereon, sometimes to a sufficient degree that smoothing of the surface in a subsequent operation may be required. Further, fiber cement felts are prone to “blinding” (the filling of the openings in the fabric mesh with fiber cement slurry) and typically must be cleaned frequently and may be removed (depending on machine conditions such as speed and load) after as little as one week. Also, such felts tend to suffer significant “compaction” (the tendency of the felt to decrease in thickness) with use. Compaction is detrimental to operation in that, as the felt decreases in thickness, the pressure exerted on the fiber cement by the pressing rolls can decrease, thereby altering the surface characteristics as well as overall physical properties of the sheet. Also, some compaction may be localized, with the result that the fiber cement can have areas of different thickness. Accordingly, once felts have become compacted, they are typically replaced.

One proposed solution to some of these issues is set forth in U.S. Pat. No. 5,891,516 to Gstrein et al. The felt disclosed therein is a laminated design, in which separate woven fabric layers are stacked upon each other and interconnected through the needling of a batt layer. The Gstrein felt has fine machine direction (MD) and cross machine direction (CMD) yarns in the top fabric layer and coarse MD and CMD direction yams in the bottom layer. Although this felt is successful in some applications, it can suffer in start-up performance because of the additional void volume that is typically created in laminated felt designs.

### SUMMARY OF THE INVENTION

The present invention is directed to fiber cement felts and methods of forming fiber cement that can improve the fiber cement product produced therewith. As a first aspect, embodiments of the present invention are directed to a fiber cement felt comprising a fabric and a batt layer. The fabric includes: a set of fine top machine direction yams; a set of coarse bottom machine direction yams; and a set of fine cross machine direction yams interwoven with the top and bottom machine direction yams in a plurality of repeat units. The batt layer overlies and is attached to the set of top machine direction yams of the fabric. The fineness of the yams of the top machine direction yarns and the cross machine direction yams can improve the surface achieved with other fiber cement felts, and can address some of the shortcomings of laminated felts.

In some embodiments, the base fabric is a duplex fabric; in other embodiments, the base fabric is a triplex fabric. The number of top machine direction yams to bottom machine direction yams can vary, with ratios of 2:1 to 5:1 being preferred.

As a second aspect, embodiments of the present invention are directed to methods of forming fiber cement. The method comprises the steps of: providing a fiber cement felt of the construction described above; depositing a fiber cement slurry on the fiber cement felt; and removing moisture from the slurry. This method can produce an improved fiber cement product.

### BRIEF DESCRIPTION OF THE FIGURES

FIG. 1 is a schematic illustration of a fiber cement forming apparatus of the present invention.

FIG. 2 is a top view of the top MD and CMD yams of a repeat unit of a duplex fabric of a fiber cement felt according to embodiments of the present invention, wherein the top batt layer has been removed.

FIG. 3 is a top view of the bottom MD yarns of the repeat unit of the felt of FIG. 2 as they interweave with the CMD yarns, the top MD yarns having been removed for clarity.

FIGS. 4A-4H are sequential section views of the felt of FIG. 2 taken along lines 4A-4A through 4H-4H in FIG. 2.

FIG. 5 is a section view of an exemplary CMD yarn of an alterative duplex fabric for a fiber cement felt according to embodiments of the present invention.

FIG. 6 is a section view of an exemplary CMD yarn of another alterative duplex fabric for a fiber cement felt according to embodiments of the present invention.

FIG. 7 is a section view of an exemplary CMD yam of an additional alterative duplex fabric for a fiber cement felt according to embodiments of the present invention.

FIG. 8 is a top view of the top MD and CMD yarns of a repeat unit of a triplex fabric of a fiber cement felt according to embodiments of the present invention, wherein the top batt layer has been removed.

FIG. 9 is a top view of the bottom MD yarns of the repeat unit of the felt of FIG. 8 as they interweave with the CMD yarns, the top MD yams having been removed for clarity.

FIGS. 10A-10H are sequential section views of the felt of FIG. 8 taken along lines 10A-10A through 10H-10H in FIG. 8.

FIG. 11 is a section view of an exemplary CMD yam of an alterative triplex fabric of a fiber cement felt according to embodiments of the present invention.

FIG. 12 is a section view of an exemplary CMD yam of another alterative triplex fabric of a fiber cement felt according to embodiments of the present invention.

FIG. 13 is a section view of an exemplary CMD yam of an additional alterative triplex fabric of a fiber cement felt according to embodiments of the present invention.

### DETAILED DESCRIPTION OF EMBODIMENTS OF THE INVENTION

The present invention will now be described more fully hereinafter, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout. Thicknesses and dimensions of some components may be exaggerated for clarity.

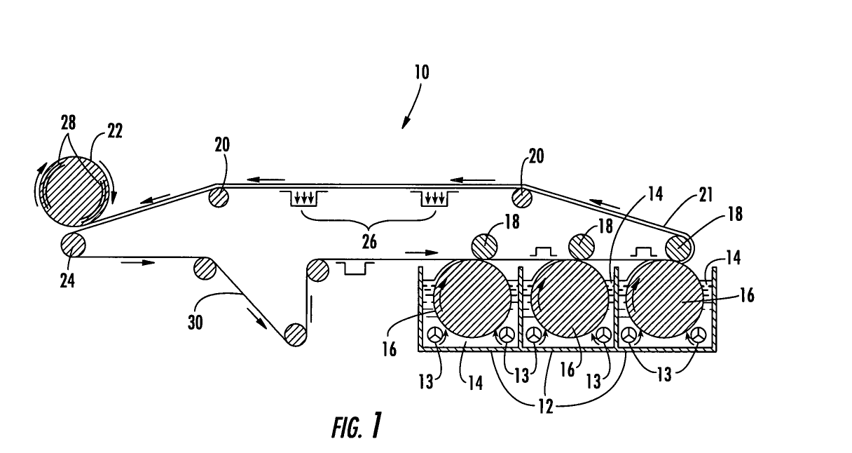

Referring now to FIG. 1, a fiber cement forming apparatus, designated broadly at 10, is illustrated therein. The forming apparatus 10, which performs a typical Hatschek process, generally includes an endless fiber cement felt 30 positioned in rolling contact with and driven by a number of guide rolls 20. Beginning in the lower right corner of FIG. 1, the felt 30 passes above three vats 12, each of which contains a batch of fiber cement slurry 14. As used herein, “fiber cement” means any cementitious composition including cement, silica, and fiber for reinforcement, including asbestos, polyvinyl alcohol, polypropylene, cotton, wood or other cellulosic material, acrylic, and aramid. It is contemplated that other materials such as thickeners, clays, pigments, and the like, that impart desirable processing or performance characteristics to the fiber cement slurry 14 or an article formed therefrom may also be included. Each vat 12 is positioned below a deposition cylinder 16 mated with a couch roll 18. Each vat 12 also includes an agitator 13 that prevents the fiber cement slurry 14 from solidifying therein.

Rotation of each deposition cylinder 16 collects fiber cement slurry 14 on the cylinder's surface; as the felt 30 travels over and contacts the cylinder 16, the slurry 14 is transferred from the cylinder 16 to the felt 30. The amount of slurry 14 deposited on the fabric 30 by each cylinder 16 is controlled by the corresponding couch roll 18. Preferably, the fiber cement slurry 14 is deposited as a web 21 at a thickness of between about 0.3 mm and 3 mm.

Still referring to FIG. 1, once the fiber cement slurry web 21 has been collected on the felt 30 from each of the vats 12, the felt 30 conveys the slurry web 21 over one guide roll 20, then over one or more suction boxes 26 (two are shown in FIG. 1), each of which applies negative pressure to the felt 30, thereby encouraging the removal of moisture from the slurry web 21. Finally, the felt 30 and the slurry web 21 pass over a second guide roll 20, then between the nip formed by a breast roll 24 and a forming roll 22. After passing through the nip, the slurry web 21 has formed into a semi-solid fiber cement sheet 28 that is collected on the surface of the forming roll 22.

Those skilled in this art will recognize that other forming apparatus are also suitable for use with the fiber cement felts of the present invention. For example, felts of the present invention can also be used to form fiber cement pipe. In such an operation, the fiber cement sheet 28 can be collected in contacting layers on a forming roll; as they dry, the overlying layers form a unitary laminated tube. Often, a pipe forming apparatus will include small couch rolls that act in concert with the forming roll to improve interlaminar strength. Also, a second felt may travel over the additional couch rolls to assist in water absorption and finishing.

The configuration of the felt 30 can be best understood by reference to FIGS. 2-4H. The felt 30 has a duplex base fabric 31 having a repeat unit that includes a set of thirty-two fine top MD yarns 32 and a set of eight coarse bottom MD yarns 34. These are interwoven with a set of eight CMD yarns 36. To clarify, as used herein the term “machine direction” refers to the direction the felt 30 travels on the fiber cement apparatus 10, and the term “cross machine direction” refers to the direction perpendicular to the machine direction and parallel to the plane defined by the felt 30. Within the felt 30, the terms “top”, “upper” and derivatives thereof refer to the portion of the felt 30 that faces the fiber cement stock (i.e., toward the sheet side of the felt 30), and the terms “bottom”, “lower” and derivatives thereof refer to the portion of the felt 30 that faces the machine components of the fiber cement forming apparatus 10 (i.e., toward the machine side of the felt 30). The term “duplex” refers to a fabric that has two sets of MD yams at different elevations within the fabric 31 interwoven with a single set of CMD yarns.

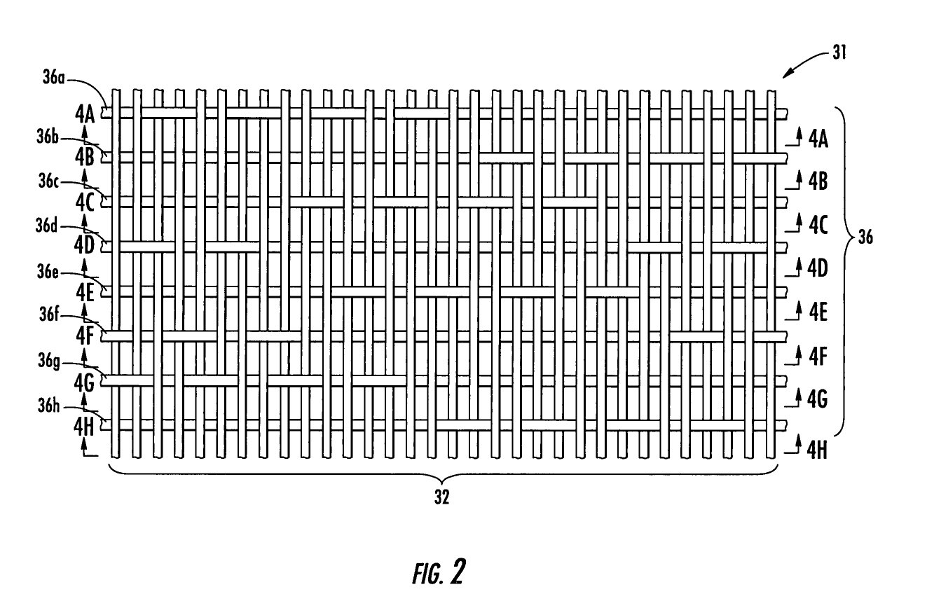

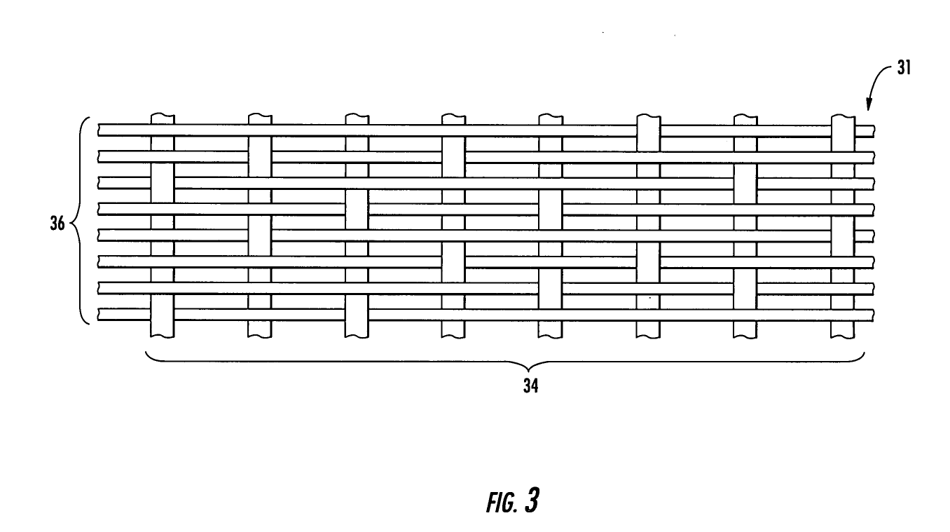

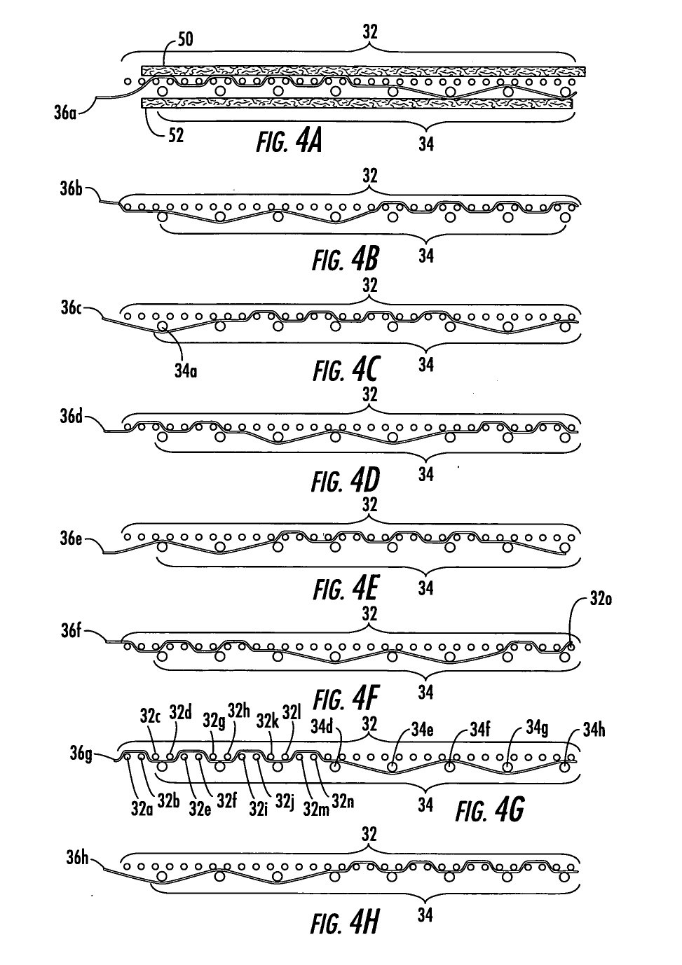

As can be seen in FIGS. 2-4H, each CMD yarn 36 follows a similar weave pattern relative to the top MD yarns 32. Referring to FIG. 4G, the CMD yarn 36g illustrated therein passes above two top MD yams 32a, 32b, below the next two top MD yarns 32c, 32d, above the next two top MD yams 32e, 32f, below the next two top MD yarns 32g, 32h, above the next two top MD yarns 32i, 32j, below the next two top MD yams 32k, 32l, above the next two top MD yarns 32m, 32n, and below the remaining eighteen top MD yams 32. As the CMD yarn 36g passes below eighteen top MD yarns, it also passes above a bottom MD yam 34d, stitches below the next bottom MD yam 34e, passes above the next bottom yarn 34f, stitches below the next bottom MD yarn 34g, and passes above the next remaining bottom MD yarn 34h before returning to the top layer of the fabric to interweave with the top MD yams 32 (and, in doing so, passing above three bottom MD yams 34).

Each CMD yarn 36 is woven adjacent another CMD yam 36 that interweaves with top MD yams 32 in a complementary manner such that, together, the adjacent CMD yams complete an entire weaving sequence with the top MD yams. As an example, CMD yarn 36h, which is illustrated in FIG. 4H, is passing below top MD yarns 32 and stitching with bottom MD yarns 34 when its adjacent CMD yarn 36g is interweaving with the top MD yarns 32 in the “over two/under two” pattern described above. Conversely, when the CMD yarn 36g is passing below eighteen consecutive top CDM yarns as described above (i.e., when it is stitching with bottom CMD yarns 34), the CMD yarn 36h is interweaving in the same type of “over two/under two” pattern with the top CMD yarns 32. As a result, together the CMD yams 36g, 36h form an unbroken “over two/under two” pattern for the entirety of the repeat unit of the fabric 31, and stitch below every other bottom MD yarn 34. Each of the other CMD yams 36 has an adjacent CMD yam with which it pairs to form the desired “over two/under two” pattern” (i.e., CMD yarns 36a, 36b form an adjacent pair, as do CMD yams 36c, 36d and 36e, 36f). Adjacent pairs of CMD yams 36 are offset from one another to enable two CMD yarns 36 to pass over every top MD yarn 32 at some location in the repeat unit, and to do so by passing over that top MD yam 32 as well as passing over each of its neighboring top MD yarns 32 once (for example, and as shown in FIGS. 4F and 4G, the leftmost top MD yarn 32a is passed over by CMD yarn 36g in conjunction with the second leftmost top MD yarn 32b, and is also passed over by CMD yarn 36f in conjunction with the rightmost top MD yarn 32o). Similarly, the pairs of CMD yarns 36 are offset from each other such that each bottom MD yarn 34 has two knuckles formed underneath it by two different CMD yarns. For example, CMD yarns 36c and 36h form knuckles below leftmost bottom MD yarn 34a.

As noted above, the top MD yams 32 are fine yarns. Exemplary fine yarns are single monofilaments with a diameter of between about 0.2 and 1.0 mm, twisted monofilaments of the same diameter range, spun yarns, multifilaments, and other twists. The CMD yams 36 are also fine yarns. Exemplary fine yams for the CMD yarns 36 include single monofilaments with a diameter of between about 0.3 and 1.0 mm, twisted monofilaments of the same diameter range, spun yarns, multifilaments, core-wrapped yams, and other twists. The bottom MD yams 34 are coarse yarns. Exemplary coarse yarns for the bottom MD yarns 36 include twists from about 300 to about 4,500 dtex, typically formed of spun yarns, cross-linked yarns, multifilaments, core-wrapped yams and twists thereof. As used herein, the term “tex” refers to the well-known unit of fineness used to describe textile yams, in which the number of tex is equal to the mass in grams of a 1000 meter length of yam. The term “dtex” refers to one-tenth of a “tex”, or the mass in grams of a 100 meter length of yarn.

The materials comprising yams employed in the fabric of the present invention may be those commonly used in fiber cement felts. For example, the yams 32,34, 36 may be formed of cotton, wool, polypropylene, polyester, aramid, polyamide, or the like, with polyamide yarns being preferred for both the top and bottom MD yarns 32, 34 and the CMD yarns 36. Of course, the skilled artisan should select yarn materials according to the parameters of the fiber cement forming process.

In one desirable embodiment, the top MD yarns 32 are monofilaments having a diameter of between 0.2 and 1.0 mm, the bottom MD yarns 34 are combination twists of multifilaments and spun yams of 300-4,500 dtex, and the CMD yarns 36 are monofilaments or twisted monofilaments having a diameter of between about 0.3 and 1.0 mm.

Referring to FIG. 4A, the felt 30 also includes upper and lower batt layers 50, 52. The batt layers 50, 52 should be formed of a material, such as a synthetic fiber like acrylic ananeid, polyester, or polyamide, or a natural fiber such as wool, that assists in taking up fiber cement slurry 14 from the vats 12 to form the fiber cement web 21. Preferred materials include polyamide, polyester and blends thereof. The weight of the batt layers 50, 52 can vary, although it is preferably that the ratio of batt weight to fabric weight is about between about 1.0 and 2.0 with 1.5 being more preferred. Also, in some embodiments, it may be desirable to omit the bottom batt layer 52. Typically, the batt layers 50, 52 are attached to the fabric 31 via needling, although other processes known to those skilled in this art may be employed.

Other weave patterns may also be employed in duplex base fabrics of the felt 30. For example, FIG. 5 illustrates a duplex fabric 130 for a felt having a repeat unit that includes sixteen fine top MD yams 132, eight coarse bottom MD yarns 134, and eight fine CMD yarns 136 (only one exemplary CMD yarn 136 is shown herein). The CMD yarns 136 are interwoven with the top MD yarns 132 such that each CMD yarn 136 forms two two-knuckle floats over top MD yarns 132 that are separated by two top MD yarns 132. Pairs of adjacent CMD yams together form an unbroken pattern of the “over two/under two” sequence much like that of the embodiment of FIGS. 2-4H. Further, each CMD yarn 136 passes below two bottom MD yarns 134 that are separated by one bottom MD yam 134. The other CMD yams 136 have a similar pattern in interweaving with the top and bottom MD yarns 132, 134, but are offset from each other such that each top MD yarn 132 passes under two different CMD yams 136, and such that each bottom MD yam 134 passes over two different CMD yams 136.

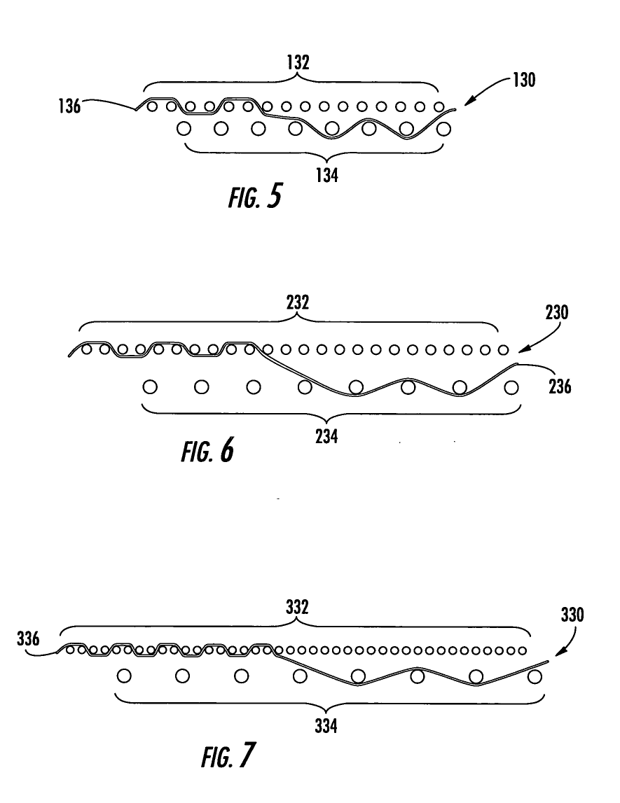

Referring now to FIG. 6, another embodiment of a duplex fabric (designated broadly at 230) that can be employed with fiber cement felt embodiments of the present invention is illustrated therein. The fabric 230 has repeat units that include a set of twenty-four fine top MD yams 232, a set of eight coarse bottom MD yams 234, and a set of eight fine CMD yarns 236. The CMD yarns 236 are interwoven with the top MD yarns 232 to form three two-knuckle floats, each of which is separated by two top MD yarns 232. The CMD yarns 236 are interwoven with the bottom MD yarns 234 such that they form two knuckles below bottom MD yams 234 that are separated by one bottom MD yarn 234. The other CMD yarns 236 have a similar pattern in interweaving with the top and bottom MD yarns 232, 234, but are offset from each other such that each top MD yarn 232 passes under two different CMD yams 236, and such that each bottom MD yarn 234 passes over two different CMD yams 236.

FIG. 7 illustrates another duplex fabric 330 that can be employed with fiber cement felt embodiments of the present invention. The fabric 330 has repeat units that include a set of forty fine top MD yarns 332, a set of eight coarse bottom MD yams 334, and a set of eight fine CMD yams 336. The CMI) yams 336 are interwoven with the top MD yams 332 to form five two-knuckle floats, each of which is separated by two top MD yams 332. The CMD yarns 336 are interwoven with the bottom MD yams 334 such that they form two knuckles below bottom MD yams 334 that are separated by one bottom MD yarn 334. The other CMD yams 336 have a similar pattern in interweaving with the top and bottom MD yarns 332, 334, but are offset from each other such that each top MD yam 332 passes under two different CMD yarns 336, and such that each bottom MD yam 334 passes over two different CMD yarns 336.

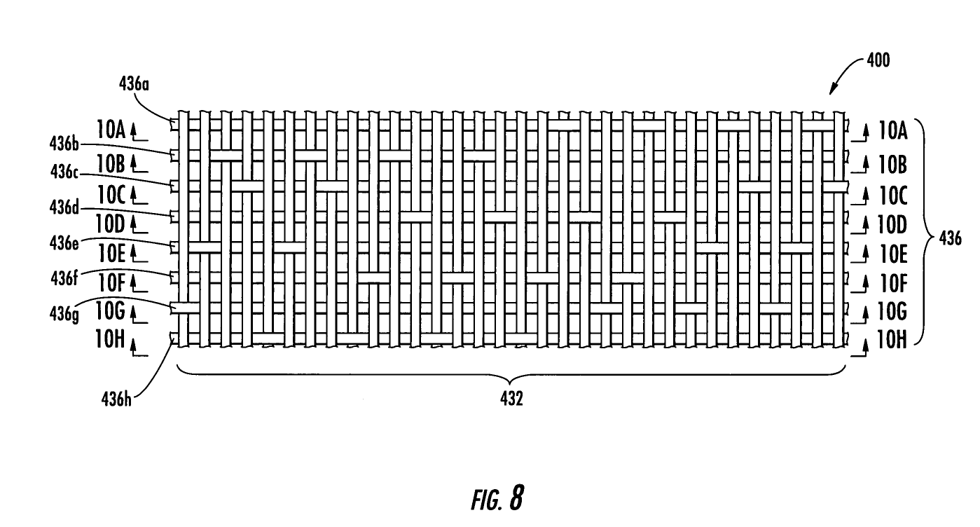

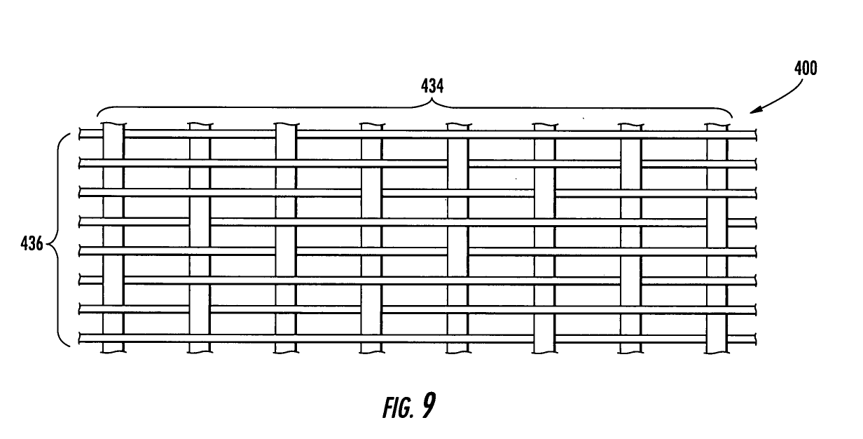

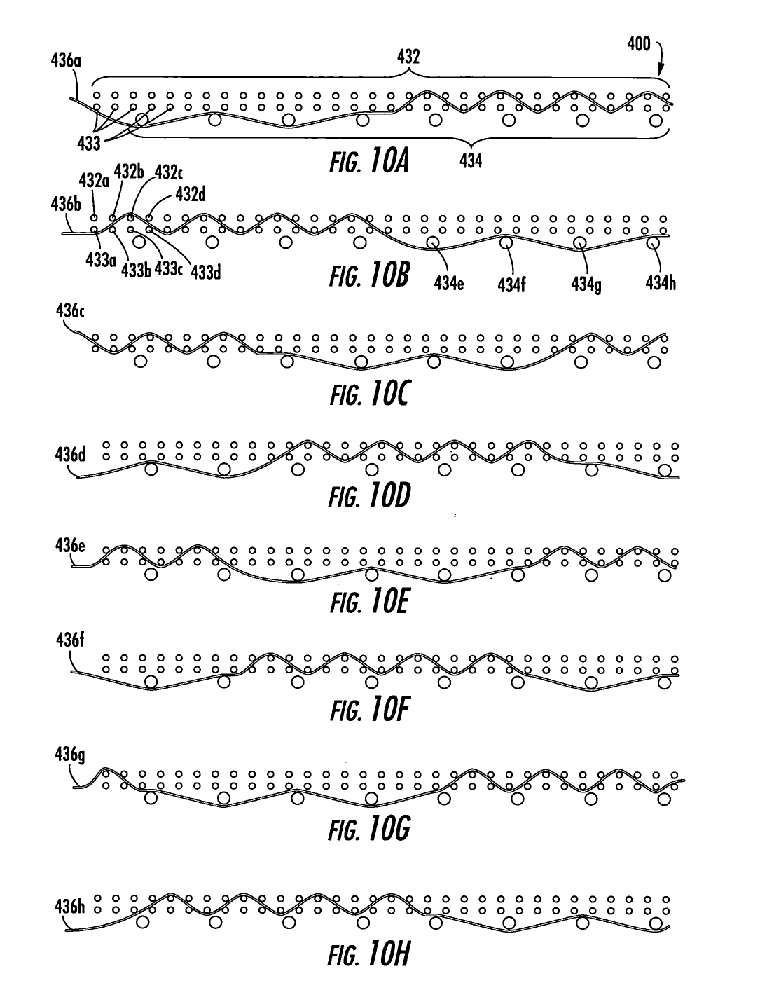

Referring now to FIGS. 8-10H, a triplex fabric 400 that is suitable for use in embodiments of the felt 30 is illustrated therein. As used herein, the term “triplex” refers to a fabric that includes three sets of MD yams at different elevations within the fabric interwoven with a set of CMD yarns. The fabric 400 has repeat units that include a set of thirty-two fine upper top MD yams 432, a set of thirty-two fine lower top MD yarns 433, a set of eight coarse bottom MD yarns 434, and a set of eight fine CMD yarns 436. As can be seen in FIGS. 10A-10H, the upper MD top yams 432 are positioned above the lower top MD yams 433. The CMD yams 436 interweave with the upper and lower top MD yams 432, 433 and the bottom MD yams 434 to form the fabric 400.

Each of the CMD yams 436 follows a similar path in interweaving with the MD yams. Using as an example CMD yam 436b (shown in FIG. 10B), the CMI yam 436b begins below one pair of upper and lower top MD yams 432a, 433a, weaves between the next pair of upper and lower top MD yams 432b, 433b, passes above the next upper top MD yarn 432c to form a knuckle thereover, and weaves between the next pair of upper and lower top MD yarns 432d, 433d. This sequence is repeated three more times with the next twelve upper and lower MD yams 432, 433. The CMD yarn 436b then passes below the next sixteen pairs of upper and lower top MD yams 432, 433 as it interweaves with the bottom MD yams 434. More specifically, the CMD yam 436b stitches below bottom MD yam 434e, passes above the next bottom MD yarn 434f, stitches below the next bottom MD yam 434g and passes above the next bottom MD yam 434h as it travels upwardly to begin the sequence again by interweaving with the upper and lower top MD yarns 432, 433.

As can be seen in FIGS. 10A-10H, each of the CMD yams follows a similar sequence: each CMD yam interweaves with the upper and lower top MD yarns such that it forms four knuckles over single upper top MD yams 432 that are separated from each other by three upper top MD yams, and each CMD yam 436 stitches below two bottom MD yams 434 that are separated from each other by one bottom MD yam 434. For each CMD yarn 436 there is an adjacent CMD yam 436 that is woven in a complementary manner, such that together the two CMD yams 436 of the pair form a continuous “over one/under three” sequence with the upper top MD yarns 432 and a continuous “over one/under one” sequence with the bottom MD yams 434. The pairs of CMD yams 436 are offset from one another such that one knuckle is formed over each upper top MD yam 432 and two knuckles are formed under each bottom MD yarn 434.

Other weave patterns may also be employed in the triplex fabrics of the felt 30. For example, FIG. 11 illustrates a triplex fabric 500 for a felt having a repeat unit that includes sixteen fine upper top MD yams 532, sixteen fine lower top MD yarns 533, eight coarse bottom MD yarns 534, and eight fine CMD yams 536 (only one exemplary CMD yam 536 is shown herein). The CMD yams 536 are interwoven with the upper and lower top MD yams 532, 533 such that two knuckles are formed over upper top MD yams 532 that are separated by three upper top MD yarns 532. Also, the CMD yams 536 are interwoven with the bottom MD yams 534 such that they stitch below two bottom MD yams 534 that are separated by one bottom MD yam 534. The other CMD yams 536 are offset from one another such that one knuckle is formed over each upper top MD yam 532 and two knuckles are formed below each bottom MD yarn 534.

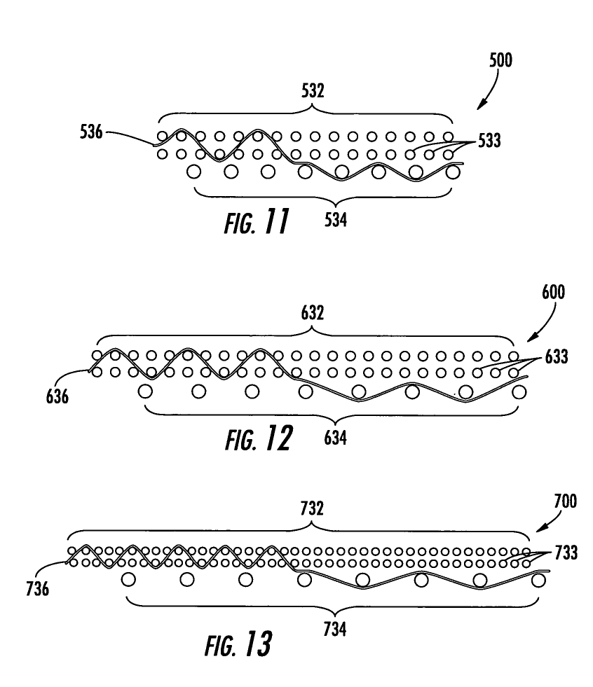

Referring now to FIG. 12, a triplex fabric 600 having a repeat unit that includes twenty-four upper top MD yams 632, twenty-four lower top MD yarns 633, eight bottom MD yarns 634 and eight CMD yams 636 is illustrated therein. The CMD yams 636 are interwoven with the upper and lower top MD yams 632, 633 such that three knuckles are formed over upper top MD yarns 632 that are separated by three upper top MD yams 632. Also, the CMD yarns 636 are interwoven with the bottom MD yams 634 such that they stitch below two bottom MD yams 634 that are separated by one bottom MD yam 634. The other CMD yams 636 are offset from one another such that one knuckle is formed over each upper top MD yam 632 and two knuckles are formed below each bottom MD yam 634.

FIG. 13 illustrates another triplex fabric 700 that can be employed with fiber cement felt embodiments of the present invention. The fabric 700 has repeat units that include forty upper top MD yams 732, forty lower top MD yams 733, eight bottom MD yams 734 and eight CMD yams 736 is illustrated therein. The CMD yams 736 are interwoven with the upper and lower top MD yams 732, 733 such that five knuckles are formed over upper top MD yams 732 that are separated by three upper top MD yams 732. Also, the CMD yams 736 are interwoven with the bottom MD yams 734 such that they stitch below two bottom MD yams 734 that are separated by one bottom MD yam 734. The other CMD yams 736 are offset from one another such that one knuckle is formed over each upper top MD yam 732 and two knuckles are formed below each bottom MD yam 734.

For all of the base fabrics 130, 230, 330, 400, 500, 600, 700 illustrated in FIGS. 5-13, the discussion above regarding the form and materials of yarns employed therein is equally applicable. Also, although not explicitly illustrated, those skilled in this art will appreciate that each of the fabrics may be attached to one or more batt layers such as the batt layers 50, 52 discussed above. It should also be understood that other weave patterns for the fabrics of the fiber cement felts of the invention may also be employed.

Fiber cement felts having fabrics as discussed above may provide significantly better sheet quality than other prior fabrics, particularly coarse single layer fabrics or double layer fabrics with a coarse upper layer. Also, felts of the present invention may have improved drainage due to more efficient pressure support, and may also have improved compaction resistance.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention. The invention is defined by the following claims, with equivalents of the claims to be included therein.

1. A fiber cement felt, comprising:
a fabric including:
a set of fine top machine direction yams;
a set of coarse bottom machine direction yams; and
a set of fine cross machine direction yarns interwoven with the top and bottom machine direction yams in a plurality of repeat units; and
a batt layer overlying and attached to the set of top machine direction yams of the fabric.

2. The fiber cement felt defined in claim 1, wherein the bottom machine direction yams are twists selected from the group consisting of: spun yarns; cross-linked yarns; multifilaments; core wrapped yams; and combinations thereof.

3. The fiber cement felt defined in claim 1, wherein the bottom machine direction yams are sized between about 300 and 4,500 dtex.

4. The fiber cement felt defined in claim 1, wherein the cross machine direction yams are selected from the group consisting of: single monofilaments and monofilament twists.

5. The fiber cement felt defined in claim 1, wherein the cross machine direction yams are sized between about 0.2 and 1.0 mm in diameter.

6. The fiber cement felt defined in claim 1, wherein the top machine direction yams are selected from the group consisting of: single monofilaments and monofilament twists.

7. The fiber cement felt defined in claim 1, wherein the top machine direction yams are sized between about 0.3 and 1.0 mm in diameter.

8. The fiber cement felt defined in claim 1, wherein the ratio of top machine direction yams to bottom machine direction yams is between 2:1 and 5:1.

9. The fiber cement felt defined in claim 1, further comprising a batt layer attached to and underlying the bottom machine direction yarns.

10. The fiber cement felt defined in claim 1, wherein the set of top machine direction yams includes upper and lower top machine direction yarns interwoven with the cross machine direction yams, such that the felt is a triplex felt.

11. The fiber cement felt defined in claim 10, wherein in each repeat unit, each cross machine direction yam forms two knuckles below bottom machine direction yams.

12. The fiber cement felt defined in claim 1 1, wherein the knuckles are separated by one bottom machine direction yam.

13. The fiber cement felt defined in claim 10, wherein in each repeat unit, only one knuckle is formed by a CMD yam over each upper top machine direction yam.

14. The fiber cement felt defined in claim 1, wherein the set of top machine direction yams is positioned such that the felt is a duplex felt.

15. The fiber cement felt defined in claim 14, wherein in each repeat unit, each cross machine direction yam forms two knuckles below bottom machine direction yarns.

16. The fiber cement felt defined in claim 15, wherein the knuckles are separated by one bottom machine direction yarn.

17. The fiber cement felt defined in claim 14, wherein in each repeat unit, two separate knuckles are formed by cross machine direction yarns over each top machine direction yarn.

18. The fiber cement felt defined in claim 14, wherein in each repeat unit, each cross machine direction yam forms multiple two-knuckle floats over adjacent top machine direction yams.

19. A method of forming a fiber cement article, comprising the steps of:
(a) providing a fiber cement felt, the fiber cement felt comprising:
a fabric including:
a set of fine top machine direction yams;
a set of coarse bottom machine direction yarns; and
a set of fine cross machine direction yams interwoven with the top and bottom machine direction yams in a plurality of repeat units; and
a batt layer overlying and attached to the set of top machine direction yams of the fabric;
(b) depositing a fiber cement slurry on the fiber cement felt; and
(c) removing moisture from the slurry.

20. The method defined in claim 19, wherein the bottom machine direction yams are twists selected from the group consisting of: spun yams; cross-linked yams; multifilaments; core wrapped yams; and combinations thereof.

21. The method defined in claim 19, wherein the bottom machine direction yams are sized between about 300 and 4,500 dtex.

22. The method defined in claim 19, wherein the cross machine direction yams are selected from the group consisting of: single monofilaments and monofilament twists.

23. The method defined in claim 19, wherein the cross machine direction yams are sized between about 0.2 and 1.0 mm in diameter.

24. The method defined in claim 19, wherein the top machine direction yams are selected from the group consisting of: single monofilaments and monofilament twists.

25. The method defined in claim 19, wherein the top machine direction yarns are sized between about 0.3 and 1.0 mm in diameter.

26. The method defined in claim 19, wherein the ratio of top machine direction yarns to bottom machine direction yarns is between 2:1 and 5:1.

27. The method defined in claim 19, further comprising a batt layer attached to and underlying the bottom machine direction yarns.

28. The method defined in claim 19, wherein the set of top machine direction yarns includes upper and lower top machine direction yarns interwoven with the cross machine direction yarns, such that the felt is a triplex felt.

29. The method defined in claim 28, wherein in each repeat unit, each cross machine direction yarn forms two knuckles below bottom machine direction yarns.

30. The method defined in claim 29, wherein the knuckles are separated by one bottom machine direction yarn.

31. The method defined in claim 28, wherein in each repeat unit, only one knuckle is formed by a CMD yarn over each upper top machine direction yarn.

32. The method defined in claim 19, wherein the set of top machine direction yarns is positioned such that the felt is a duplex felt.

33. The method defined in claim 32, wherein in each repeat unit, each cross machine direction yarn forms two knuckles below bottom machine direction yarns.

34. The method defined in claim 33, wherein the knuckles are separated by one bottom machine direction yarn.

35. The method defined in claim 32, wherein in each repeat unit, two separate knuckles are formed by cross machine direction yarns over each top machine direction yarn.

36. The method defined in claim 32, wherein in each repeat unit, each cross machine direction yarn forms multiple two-knuckle floats over adjacent top machine direction yarns.
